(19) United States
(12) Patent Application Publication
(10) Pub. No.: US 2010/0011265 A1
(43) Pub. Date: Jan. 14, 2010

(54) INTEGRATED CIRCUIT CHIP AND CIRCUIT NETWORK

(75) Inventors: Hirotaka Tamura, Kawasaki (JP); Masaya Kibune, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/562,648

(22) Filed: Sep. 18, 2009

Related U.S. Application Data
(63) Continuation of application No. PCT/JP2007/055994, filed on Mar. 23, 2007.

(51) Int. Cl. G06F 11/273

(52) U.S. Cl. 714/734; 714/E11.17

(57) ABSTRACT

An integrated circuit chip includes a plurality of two-way transceivers capable of simultaneously transmitting and receiving signals, a switch circuit coupled to the plurality of two-way transceivers and to a given node to provide switchable couplings between the plurality of two-way transceivers and the given node, an interconnection information storage unit to store interconnection information, and a control circuit to set the couplings of the switch circuit in response to the interconnection information.

### CROSS-REFERENCE TO RELATED APPLICATIONS

This is a continuation of International Application No. PCT/JP2007/055994, filed on Mar. 23, 2007, the entire contents of which are hereby incorporated by reference.

### FIELD

The disclosures herein generally relate to integrated circuit chips, circuit networks, an integrated circuit chip having a signal transmission function to perform high-speed signal transmission between LSI chips and to a circuit network comprised of such integrated circuit chips.

### BACKGROUND

Performance has been greatly increasing with respect to component devices such as SRAM (Static Random Access Memory), DRAM (Dynamic Random Access Memory), processors, and switching-purpose LSI, which constitute information processing apparatuses such as computers. Together with increases in the performance of such component devices and elements, the speed of signal transmission between the component devices and elements may need to be increased (i.e., by increasing transmission bandwidth and decreasing transmission delay). Otherwise, the overall performance of the system as a whole may not be improved. For example, a speed difference between a processor and a memory such as SRAM or DRAM has been increasing. In recent years, such a speed difference has been becoming a major factor that prevents the performance of computers from being improved. Not only signal transmission between chips such as SRAM, DRAM, and processors but also signal transmission speed between devices and circuit blocks inside a chip have been becoming a major factor to limit chip performance as the chip size increases. Moreover, there may also be a need to increase signal transmission speed with respect to couplings between servers and between boards.

In a typical configuration used for a system comprised of a plurality of chips, chips contained in packages are arranged on a printed circuit board, and are coupled via traces on the printed circuit board. These traces on the printed circuit board are likely to intersect one another in a complex pattern. In consideration of this, a multilayer printed-circuit board is widely used to provide multiple layers for interconnection. Also, a plurality of chips may often be coupled to a single signal line.

With such interconnections, signal quality may degrade due to interference between signals and multiple signal reflections caused by impedance mismatch at multi-drop joint points. For the purpose of preventing the degradation of signal quality, there may be a need to spend a sufficient time carefully designing a printed circuit board. This tends to result in high price. Also, when the system is to be modified, it is not easy to change interconnections on the printed circuit board. Recreating the entire board may thus be performed.

For the purpose of achieving high speed signal transmission, it is effective to implement each interconnection as a one-to-one signal coupling and to terminate the opposite ends of this interconnection by its characteristic impedance. Since a one-to-one coupling does not transmit a signal from one terminal to a plurality of points, an increased number of terminals end up being required. The number of terminals increases as the chip functionality is improved. With the present technology, however, it is not easy to increase the number of package pins. It is thus not desirable to have an increased number of terminals due to the use of a one-to-one-coupling scheme.

[Patent Document 1] Japanese Laid-open Patent Publication No. 2001-268141

### SUMMARY

According to an aspect of the embodiment, An integrated circuit chip includes a plurality of two-way transceivers capable of simultaneously transmitting and receiving signals, a switch circuit coupled to the plurality of two-way transceivers and to a given node to provide switchable couplings between the plurality of two-way transceivers and the given node, an interconnection information storage unit to store interconnection information, and a control circuit to set the couplings of the switch circuit in response to the interconnection information.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating an example of a basic configuration of a semiconductor integrated circuit chip;

FIG. 2 is a drawing illustrating an example of the configuration of a network between chips implemented;

FIG. 3 is a flowchart illustrating the procedure of controlling coupling settings by sending ID information and interconnection information;

FIG. 4 is a timing chart illustrating the operation timing of coupling setting control performed by sending ID information and interconnection information;

FIG. 5 is a drawing for explaining a mechanism for setting couplings between two-way transceivers in the switch circuit;

FIG. 6 is a drawing for explaining the configuration of the hybrid circuit;

FIG. 7 is a drawing illustrating an example of the configuration for controlling a high impedance state in the integrated circuit chip;

FIG. 8 is a flowchart illustrating a process of setting an output to a high impedance state;

FIG. 9 is a drawing illustrating a first embodiment of the integrated circuit chip;

FIG. 10 is a drawing illustrating an example of the configuration of a network using the integrated circuit chips of FIG. 9;

FIG. 11 is a drawing illustrating a second embodiment of the integrated circuit chip;

FIG. 12 is a drawing illustrating an example of the configuration of a network using the integrated circuit chip and device of FIG. 11;

FIG. 13 is a drawing illustrating a third embodiment of the integrated circuit chip;

FIG. 14 is a drawing illustrating a fourth embodiment of the integrated circuit chip;

FIG. 15 is a drawing illustrating an example of the configuration of a clock-data-recovery circuit;

FIG. 16 is a drawing illustrating an example of the configuration that uses a burst mode CDR in the integrated circuit chip;

FIG. 17 is a drawing illustrating an example of the configuration of the burst CDR circuit;

FIG. 18 is a drawing illustrating data sampling timings in burst CDR;

FIG. 19 is a drawing illustrating an example of the configuration in which a clock source for signal transmission is selectable;

FIG. 20 is a drawing illustrating a fifth embodiment of the integrated circuit chip; and

FIG. 21 is a flowchart illustrating an example of the process of setting a chip ID to each chip.

### DESCRIPTION OF EMBODIMENTS

In the following, embodiments will be described with reference to the accompanying drawings.

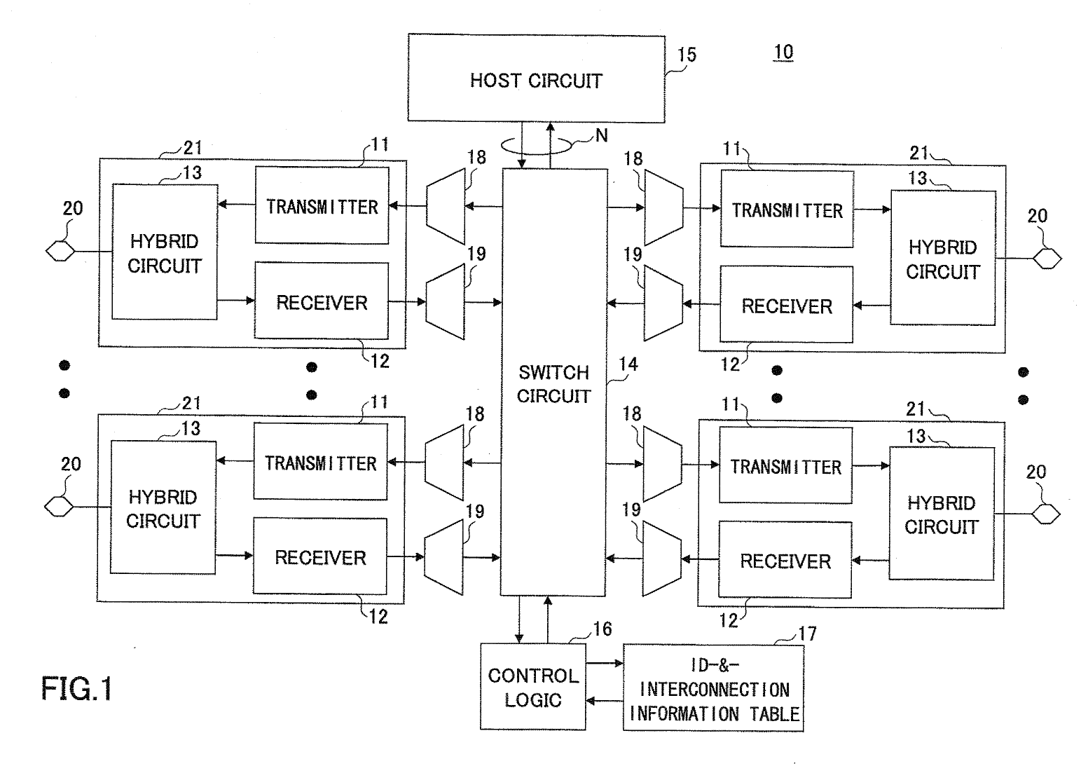

FIG. 1 is a drawing illustrating an example of a basic configuration of a semiconductor integrated circuit chip. An integrated circuit chip 10 illustrated in FIG. 1 includes a plurality of transmitters 11, a plurality of receivers 12, a plurality of hybrid circuits 13, a switch circuit 14, a host circuit 15, a control logic 16, an ID-&-interconnection information table 17, a plurality of multiplexers 18, a plurality of demultiplexers 19, and a plurality of two-way input-output ports 20.

One two-way transceiver 21 is comprised of one transmitter 11, one receiver 12, and one hybrid circuit 13. Two-way transceivers 21 implemented in this manner are coupled to the switch circuit 14. The hybrid circuit 13 makes it possible that signal outputting by the transmitter 11 and signal inputting by the receiver 12 are simultaneously performed. The hybrid circuit 13 has the function to separate an input signal from a signal including the input signal and an output signal superimposed on each other as they appear at the two-way input-output port 20 and to supply the separated input signal to the receiver 12.

Each of the multiplexers 18 serves to multiplex low-speed parallel signals inside the chip into a high-speed serial signal for transmission to outside the chip. Each of the demultiplexers 19 serves to demultiplex a high-speed serial signal received from outside the chip into low-speed parallel signals for provision to inside the chip.

The switch circuit 14 is coupled to the two-way transceivers 21 via the multiplexers 18 and the demultiplexers 19, and is also coupled to the host circuit 15 via a node N. The switch circuit 14 provides switchable couplings between the two-way transceivers 21. The switch circuit 14 also provides switchable couplings between the two-way transceivers 21 and the host circuit 15 (i.e., a processor, logic circuits, memory, etc.) inside the chip. Switchable couplings of the switch circuit 14 are controlled by the control logic 16. Specifically, the control logic 16 controls internal coupling states in the switch circuit 14 in response to information stored in the ID-&-interconnection information table 17.

The control logic 16 receives ID information and interconnection information from outside the integrated circuit chip 10 via dedicated ID-&-interconnection information input terminals or via the two-way input-output ports 20 provided for data input and output purposes. The control logic 16 stores the received ID information and interconnection information in the ID-&-interconnection information table 17. Further, the control logic 16 checks whether coupling from another port exists with respect to each two-way input-output port 20 based on the interconnection information stored in the ID-&-interconnection information table 17. Based on the check result indicative of either presence or absence of a coupling with another port, and based on the presence or absence of a signal input from another port, the control logic 16 sets an output to a high impedance state at the two-way input-output port 20 that is to be used to output a signal corresponding to such a signal input. The detection of presence or absence of signal input may be provided at each two-way input-output port 20.

Integrated circuit chips 10 as illustrated in FIG. 1 may be used to implement a system. In such a system, information indicative of couplings between the chips may be transmitted to each chip so that the couplings of the switch circuit 14 inside each chip are controlled based on this information, thereby setting relationships between signal senders and receivers in any desired manner. When signal transmission is performed between the chips after setting the relationships between the signal senders and receivers, each and every signal transmission is achieved through a one-to-one coupling (i.e., point-to-point coupling) from a two-way input-output port 20 to another two-way input-output port 20, thereby attaining high-speed signal transmission. Any desired coupling is established by use of the switchable coupling function of the switch circuit 14. This ensures the flexibility of interconnections, and reduces the number of pins. Since the two-way input-output port 20 is usable as both an input port and an output port without a distinction therebetween, physical couplings between the chips may be freely established without considering which is an input port and which is an output port. This serves to further reduce the number of pins.

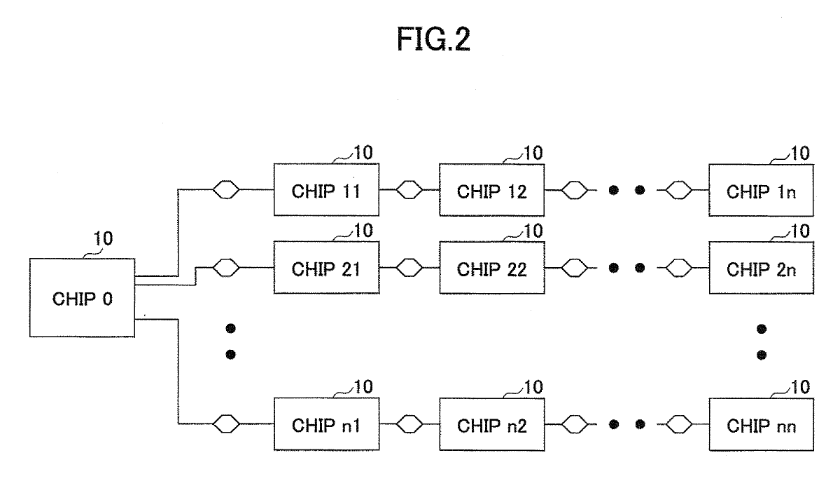

FIG. 2 is a drawing illustrating an example of the configuration of a network between chips implemented. Integrated circuit chips 10 are coupled together to form a network. A chip having a chip ID equal to 0 is a root device serving as a parent, and is situated at the root position of the network tree. Child devices having chip IDs equal to 11 through n1 are directly coupled to this root device. Grandchild devices having chip IDs equal to 12 through n2 are directly coupled to these child devices (chip IDs: 11 through n1), respectively. Similarly, further devices are cascade-coupled in a chain coupling. Each device is an integrated circuit chip 10 having the configuration illustrated in FIG. 1. According to the present embodiment, the switch circuit 14 of the integrated circuit chips 10 is controlled to switch signal transmissions between the devices, thereby providing a network that may be flexibly modified in response to a system request.

Attention may be focused, for example, on the n devices having chip IDs equal to 11 through 1n that are cascade-coupled in a chain coupling extending from the root device having a chip ID equal to 0. It may be understood that these n devices achieve an interconnection that is functionally equivalent to a multi-drop-type bus coupling. Namely, the couplings of the switch circuit 14 of each device may be set in such a fashion that 1-to-n multi-drop couplings are provided from the host circuit 15 of the root-device integrated circuit chip 10 to the host circuits 15 of the remaining n integrated circuit chips 10.

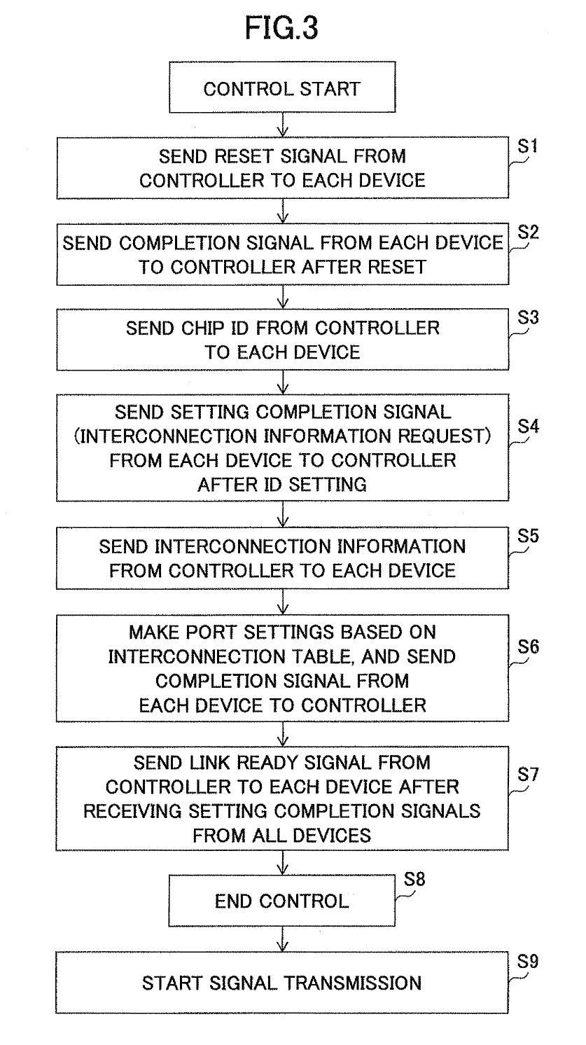

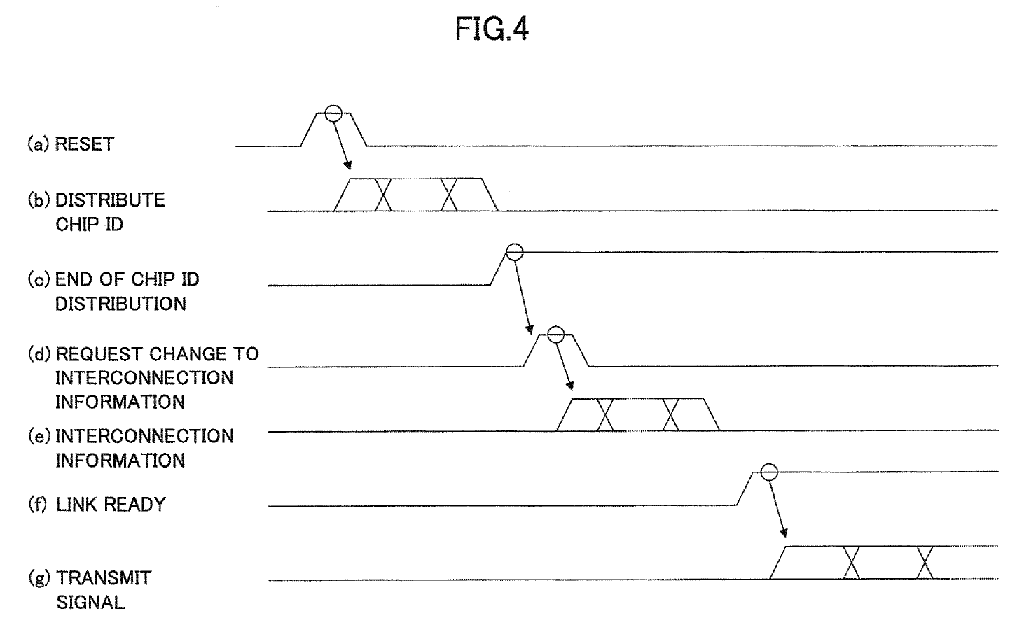

FIG. 3 is a flowchart illustrating the procedure of controlling coupling settings by sending ID information and interconnection information. The root device having a chip ID equal to 0 in FIG. 2, for example, is used as a controller, which sends information to each device. FIG. 4 is a timing chart illustrating the operation timing of coupling setting control performed by sending ID information and interconnection information.

In the following, a description will be given of the operation of coupling setting control by referring to FIG. 3 and FIG. 4. It should be noted that the control of coupling settings through transmission of ID information and interconnection information may be performed either through dedicated ID-&-interconnection information input terminals or through the two-way input-output ports 20 provided for data input and output purposes. In the following, a description will be given of the case in which the dedicated ID-&-interconnection information input terminals are used.

In step S10, a reset signal is sent from the controller to each device. This is achieved by the controller activating a reset signal line that is coupled to a reset signal terminal of each device, for example. Sending of the reset signal is illustrated in FIG. 4(a).

In step S2, each device sends a completion signal to the controller after a reset. Namely, the control logic 16 (see FIG. 1) of each device notifies the controller of a reset completion via a control signal line that extends from each device to the controller.

In step S3, a chip ID is sent from the controller to each device. Namely, the controller notifies each device's control logic 16 of its chip ID via a control signal line that extends from the controller to the ID-&-interconnection information input terminal of each device. Sending of a chip ID is illustrated in FIG. 4(b).

In step S4, each device sends a setting completion signal to the controller after the setting of an ID. Namely, the control logic 16 of each device notifies the controller of a setting completion via a control signal line that extends from each device to the controller. The setting completion signal also serves as a request for interconnection information. Sending of the setting completion signal (i.e., sending of an interconnection information request) is illustrated in FIG. 4(d).

In step S5, interconnection information is sent from the controller to each device. Namely, the controller notifies each device's control logic 16 of its interconnection information via a control signal line that extends from the controller to the ID-&-interconnection information input terminal of each device. Sending of the interconnection information is illustrated in FIG. 4(e). The control logic 16 of each device stores the received interconnection information in the ID-&-interconnection information table 17. This interconnection information defines couplings between the two-way input-output ports 20 and couplings between the two-way input-output ports 20 and the host circuit 15. Namely, the interconnection information indicates which two-way input-output ports 20 are coupled to which two-way input-output ports 20 and which two-way input-output ports 20 are coupled to the host circuit 15.

In step S6, each device makes settings for its ports based on the interconnection table, and sends a completion signal to the controller. Namely, the control logic 16 of each integrated circuit chip 10 makes settings for couplings of the switch circuit 14 in response to the interconnection information stored in the ID-&-interconnection information table 17, thereby establishing coupling conditions specified by the interconnection information (i.e., couplings between the two-way input-output ports 20 and couplings between the two-way input-output ports 20 and host circuit 15). After this, the control logic 16 of each integrated circuit chip 10 notifies the controller of a completion signal via a control signal line that extends from each device to the controller.

In step S7, the controller sends a link ready signal to each device after receiving the setting completion signal from all the devices. Namely, the controller notifies each device's control logic 16 of the link ready signal via a control signal line that extends from the controller to each device. Sending of the link ready signal is illustrated in FIG. 4(f).

In step S8, the control comes to an end. Thereafter, signal transmission commences in step S9. Signal transmission is illustrated in FIG. 4(g).

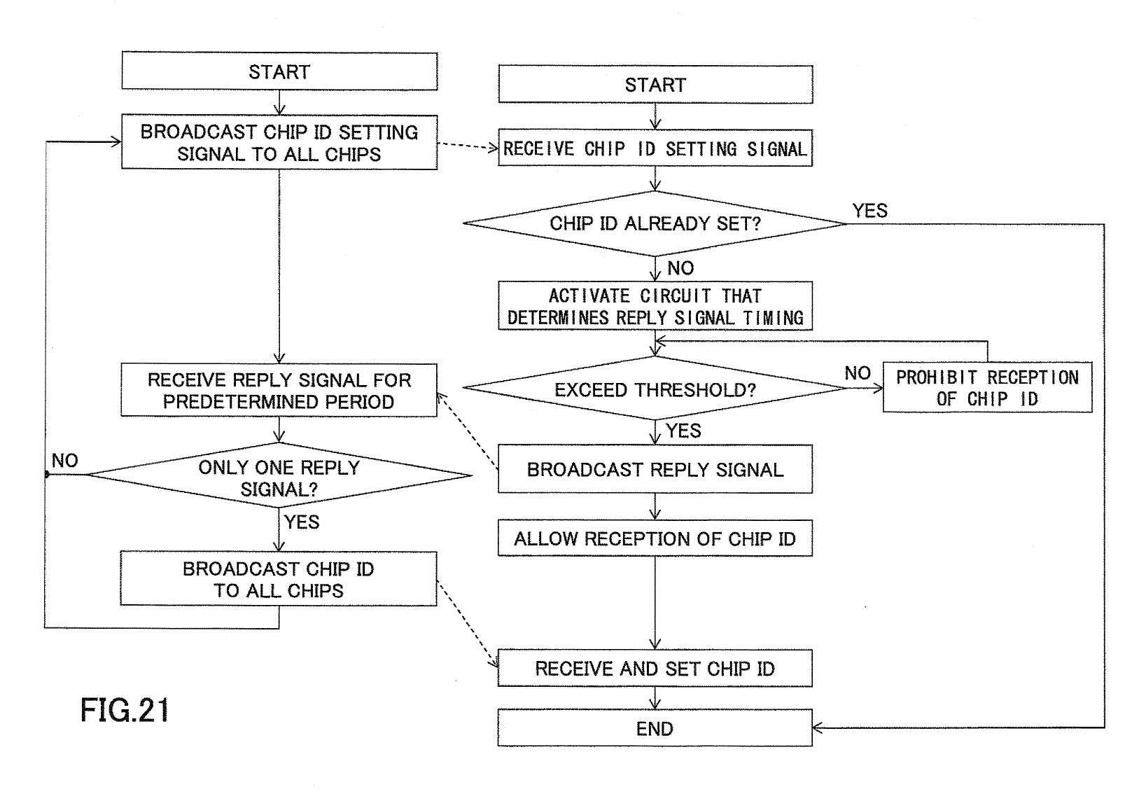

In the following, a description will be given of an example of setting a chip ID to each chip in step S2. FIG. 21 is a flowchart illustrating an example of the process of setting a chip ID to each chip. The controller broadcasts a chip-ID setting signal to all chips. After the broadcasting, the controller awaits a response from the chips for a certain period. A chip whose chip ID has not yet been decided sends a request signal to the controller in response. This chip is placed in a state to receive a chip ID for a certain period upon transmitting the request signal. The timing of each chip's transmission is designed to be random for each chip. For example, a timing at which thermal noise exhibits its magnitude exceeding a certain threshold may be used as such transmission timing. The controller broadcasts a chip ID upon detecting a response from one chip during the waiting period. If request signals from plural chips are detected, the controller does not transmit a chip ID, but transmits a broadcast signal again. A chip that is in the state to be able to receive a chip ID receives a chip ID sent from the controller and makes a setting. The above-described process is repeated as many times until chip IDs are set in all the chips.

The above description has been given of a case in which coupling settings are made by transmitting ID information and interconnection information via dedicated ID-&-interconnection information input terminals. A similar process may as well be performed via the two-way input-output ports 20. In such a case, the switch circuit 14 of each device may be configured to have such settings in the initial state following a reset that a signal input from an adjacent chip situated on one side is transmitted to another adjacent chip situated on another side. In such a state, the signal transmitted from the controller to each device may include a specific identification signal, which causes the control logic 16 of each device to recognize ID information and interconnection information. Further, the controller may keep records of coupling routes between devices based on the transmission and transfer of route requests and the returning of route replies similarly to the manner performed by the protocols such as AODV or OLSR defined in the IETF (Internet Engineering Task Force). The controller may generate interconnection information about each device based on the route information kept as records, followed by transmiting the interconnection information to each device.

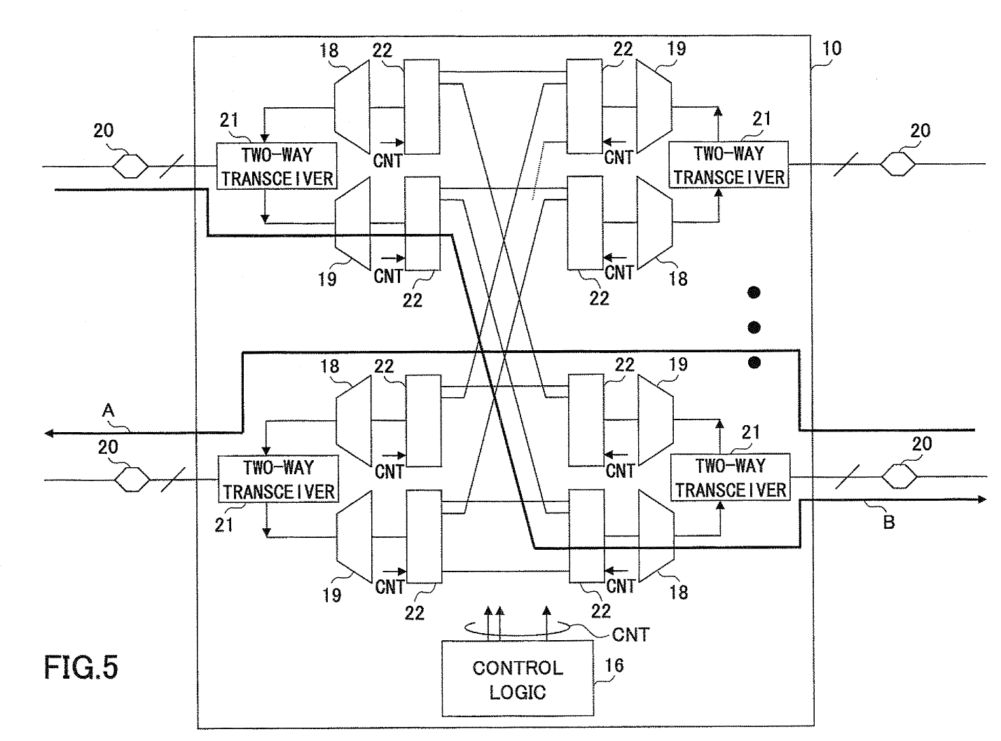

FIG. 5 is a drawing for explaining a mechanism for setting couplings between two-way transceivers in the switch circuit 14. In FIG. 5, the similar elements as those of FIG. 1 are referred to by the similar numerals, and a description thereof will be omitted. The host circuit 15 and the ID-&-interconnection information table 17 are omitted from illustration in FIG. 5. Each of the illustrated two-way transceivers 21 includes one transmitter 11, one receiver 12, and one hybrid circuit 13 as illustrated in FIG. 1.

The switch circuit 14 includes a plurality of selectors 22. Each selector 22 receives a corresponding control signal CNT from the control logic 16, and selects an input signal indicated by the control signal CNT for outputting. In this manner, the control logic 16 sets the control signals CNT to specify couplings between the two-way input-output ports 20. The setting of control signals CNT by the control logic 16 is performed in response to the interconnection information stored in the ID-&-interconnection information table 17.

In the manner as described above, a signal transmission route indicated by an arrow A and a signal transmission route indicated by an arrow B are established, for example. Although the signal couplings between the two-way input-output ports 20 are illustrated in FIG. 5, signal couplings between the two-way input-output ports 20 and the host circuit 15 are similarly established.

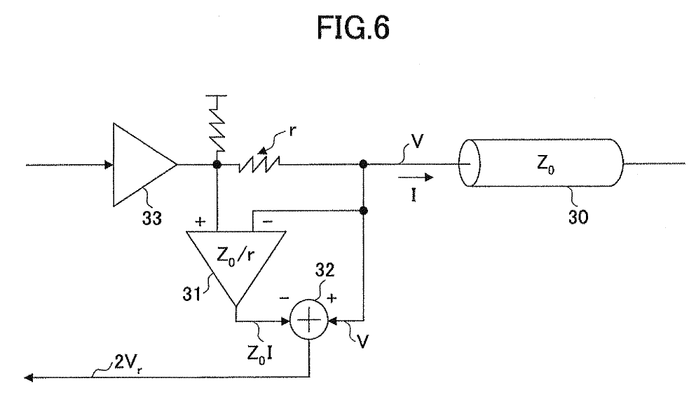

FIG. 6 is a drawing for explaining the configuration of the hybrid circuit 13. In FIG. 6, a transmission voltage V_{f} output from a transmitter 33 is transmitted to a transmission line 30 having a characteristic impedance Z₀. Further, a received voltage Vᵣ arrives from outside via the transmission line 30. A voltage V (=V_{f}+Vᵣ) appears as a superimposition of the transmission voltage V_{f} on the received voltage Vᵣ. With the amount of current flowing through a resistance having a resistance value r denoted as I, a voltage difference between the input terminals of an amplifier circuit 31 having a gain Z₀/r is rI. Accordingly, the output of the amplifier circuit 31 is equal to (Z₀/r)×rI=Z₀I. A subtractor 32 subtracts Z₀I output from the amplifier circuit 31 from the voltage V (=V_{f}+Vᵣ). Accordingly, the output of the subtractor 32 becomes as follows.

V_{f}+Vᵣ−Z₀I=V_{f}+Vᵣ−Z₀[(V_{f}−Vᵣ)/Z₀]=2Vᵣ

In this manner, the received voltage Vᵣ may be properly detected by use of a circuit configuration as shown in FIG. 6 even when a transmission signal voltage and a received signal voltage are simultaneously present and superimposed on each other. The hybrid circuit 13 illustrated in FIG. 1 has the circuit as illustrated in FIG. 6 embedded therein to detect a received signal for provision to the receiver 12.

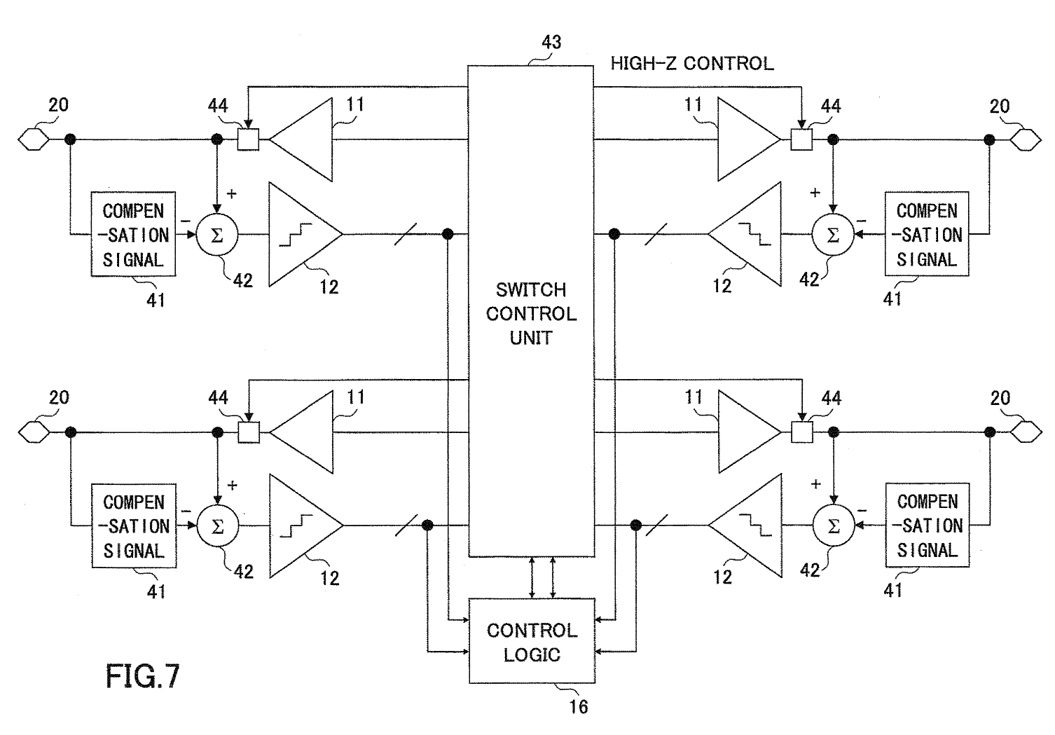

FIG. 7 is a drawing illustrating an example of the configuration for controlling a high impedance state in the integrated circuit chip. The host circuit 15 and the ID-&-interconnection information table 17 illustrated in FIG. 1 are omitted from illustration in FIG. 7. The hybrid circuit 13 illustrated in FIG. 1 is illustrated herein as a compensation signal circuit 41 and a subtractor 42 having the circuit configuration illustrated in FIG. 6. Further, the switch circuit 14, the multiplexers 18, and the demultiplexers 19 illustrated in FIG. 1 are consolidated and illustrated as a switch control unit 43.

In the configuration illustrated in FIG. 7, the receiver 12 that is a three-value comparator receives an input signal. The receiver 12 detects which one of +1, −1, and a high impedance state is the input signal voltage, and outputs the detection result. When a given two-way input-output port 20 is not coupled to a signal transmission device via a signal line, or when a signal transmission device coupled to such a signal line is placed in a high impedance state, the signal arriving at the two-way input-output port 20 is 0. The receiver 12 outputs 0 if the signal arriving at the two-way input-output port 20 is 0, outputs +1 if the arriving signal is +1, and outputs −1 if the arriving signal is −1. By monitoring the output of the receiver 12 that is a tertiary comparator, the control logic 16 is able to detect whether or not a signal input into each two-way input-output port 20 is in the high impedance state.

The control logic 16 knows couplings between the two-way input-output ports 20 and couplings between the two-way input-output ports 20 and the host circuit 15 based on the interconnection information stored in the ID-&-interconnection information table 17 (see FIG. 1). Accordingly, provision may be made such that when an input signal is in the high impedance state, the corresponding output signal is placed in a high impedance state. In the example illustrated in FIG. 7, the switch control unit 43 controls the open or closed state of gates 44 under the control of the control logic 16, thereby providing an high impedance output state by blocking the output of the transmitters 11 according to need.

Setting of an output to an high impedance state makes it possible to reduce power consumption in the system. Further, such an arrangement may automatically detect whether a two-way input-output port 20 of interest is coupled to a signal line, thereby making it possible to detect a line decoupling and a transmitter failure. The use of these functions serves to provide redundancy to lines, thereby improving the reliability of the system.

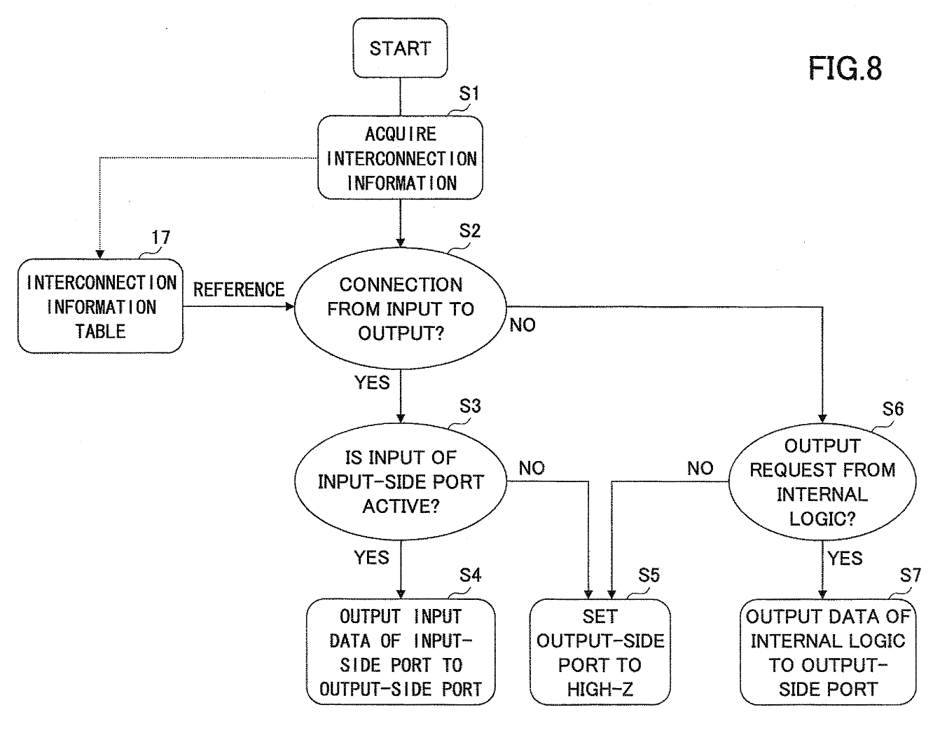

FIG. 8 is a flowchart illustrating a process of setting an output to a high impedance state. In step S1, the control logic 16 acquires interconnection information for storage in the ID-&-interconnection information table 17. In step S2, the control logic 16 refers to the interconnection information stored in the ID-&-interconnection information table 17 to decide whether there is a coupling from the input side of a given two-way input-output port 20 to the output side of another two-way input-output port 20. If there is such a coupling, the control logic 16 checks in step S3 whether the input signal of the input-side port is active. Namely, the control logic 16 monitors the output of the receiver 12 that is a tertiary comparator thereby to check whether the input signal is in the high impedance state.

If the input signal is active, the input signal of the input-side port is output to the output-side port in step S4. In this case, thus, the gate 44 illustrated in FIG. 7 is not closed. If the input signal is not active, the output-side port is placed in an high impedance state in step S5. In this case, thus, the gate 44 illustrated in FIG. 7 is closed.

If the check in step S2 finds that there is no coupling, a check is made in step S6 as to whether there is an output request issued by the internal logic. Namely, a check is made as to whether the host circuit 15 (see FIG. 1) requests to output to the two-way input-output port 20 of interest. If there is no output request, the output-side port is placed in an high impedance state in step S5. Namely, the gate 44 illustrated in FIG. 7 is closed. If there is an output request, data from the internal logic is output to the output-side port in step S7. In this case, thus, the gate 44 illustrated in FIG. 7 is not closed.

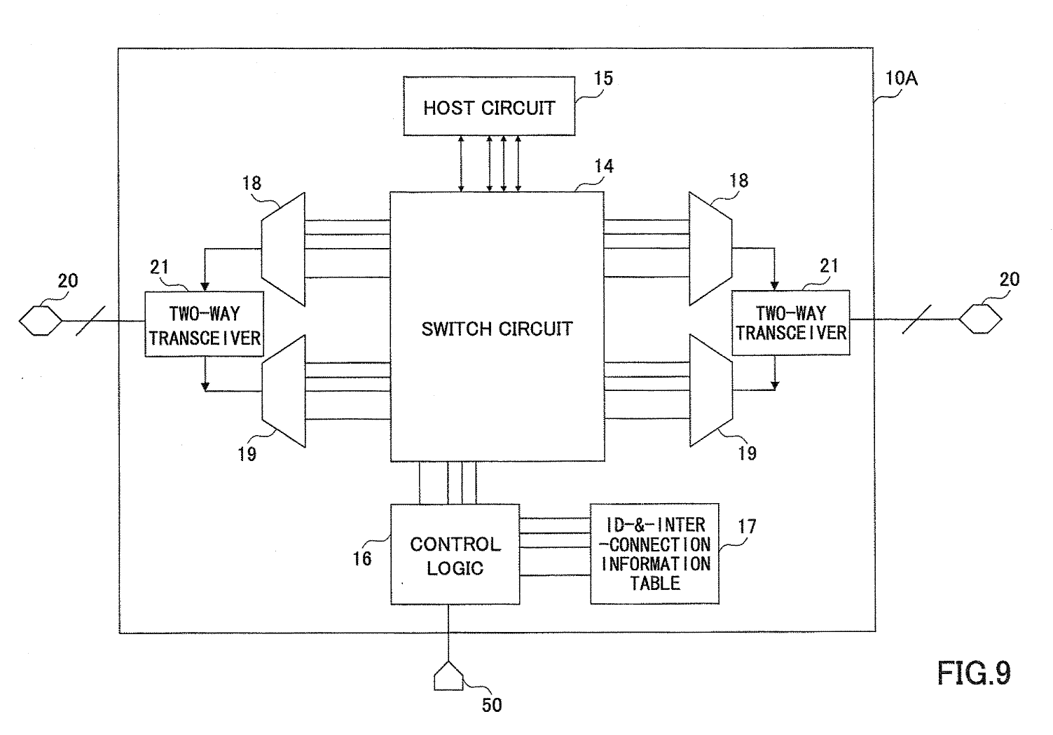

FIG. 9 is a drawing illustrating a first embodiment of the integrated circuit chip. In FIG. 9, the similar elements as those of FIG. 1 are referred to by the similar numerals, and a description thereof will be omitted. Although two two-way input-output ports 20 are illustrated in FIG. 9, two or more two-way input-output ports 20 and corresponding two-way transceivers 21 may be provided as in FIG. 1. The similar applies in the case of remaining drawings presented after FIG. 9.

An integrated circuit chip 10A illustrated in FIG. 9 includes an interconnection information input terminal 50 coupled to the control logic 16. In this configuration, the control logic 16 receives interconnection information from the controller device via the interconnection information input terminal 50. The acquisition of interconnection information and the setting of couplings are the similar to described with reference to FIG. 3 and FIG. 4.

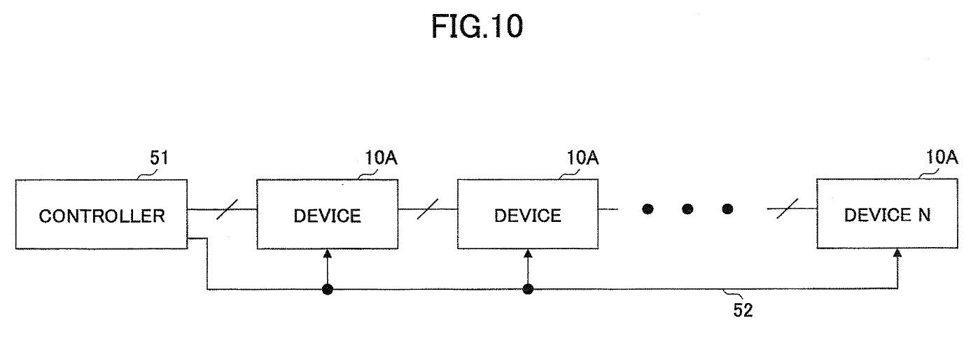

FIG. 10 is a drawing illustrating an example of the configuration of a network using the integrated circuit chips 10A of FIG. 9. Integrated circuit chips (devices) 10A are cascade-coupled in a chain coupling starting at a controller 51. In this configuration, interconnection information is supplied from the controller 51 to the interconnection information input terminal 50 of each integrated circuit chip 10A via a control signal line 52.

The network configuration illustrated in FIG. 10 has a simple topology in which the integrated circuit chips 10A are cascade-coupled from a start point at the controller 51. In terms of signal transmission, however, it is possible to perform substantially simultaneous signal transmission from the controller 51 to all the devices 10A, data transfer from any given device 10A to the controller 51, and a direct signal exchange between the devices 10A without using the controller 51 as an intervening device. In such a configuration, the network has a limited topology, which provides an advantage in that simple control circuits suffice, yet, at the similar time, sufficiently flexible interconnections may be achieved.

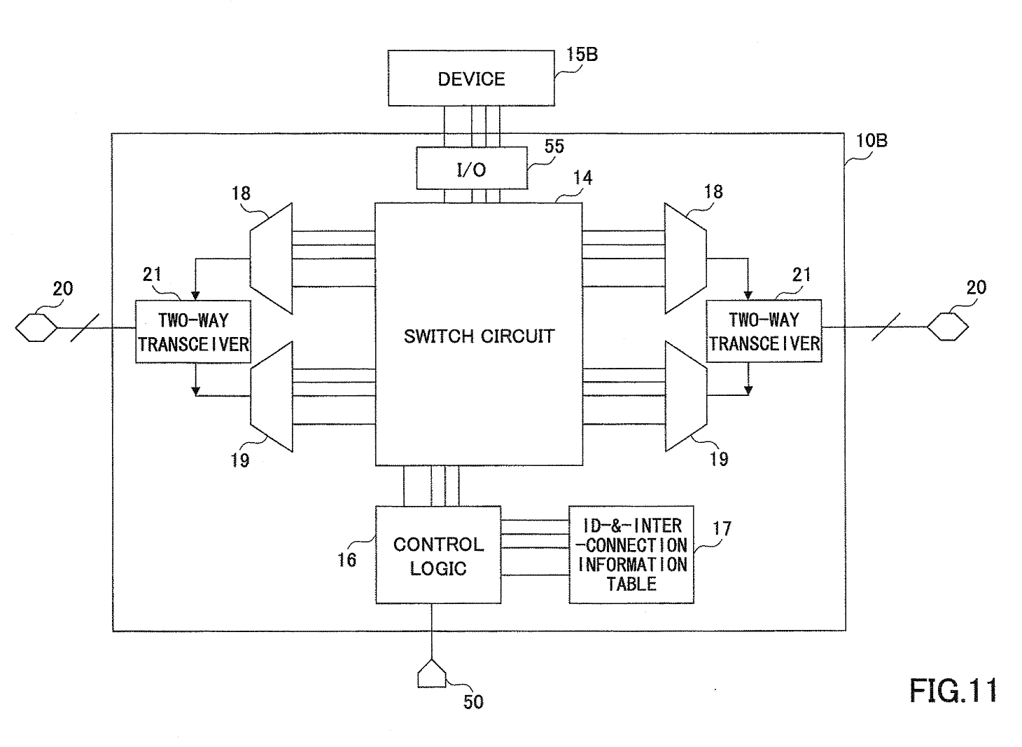

FIG. 11 is a drawing illustrating a second embodiment of the integrated circuit chip. In FIG. 11, the similar elements as those of FIG. 9 are referred to by the similar numerals, and a description thereof will be omitted.

An integrated circuit chip 10B illustrated in FIG. 11 differs from the integrated circuit chip 10A illustrated in FIG. 9 in that the host circuit 15 is provided as an externally attached device 15B which is coupled to a dedicated I/O port 55 of the integrated circuit chip 10B. The integrated circuit chip 10 solely performs control for signal input and output, switching, etc., and the externally attached device 15B provides a logic operation function and a memory function.

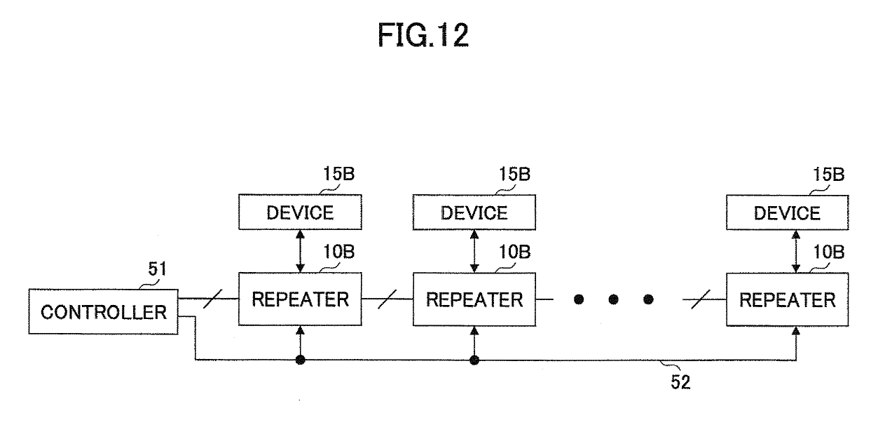

FIG. 12 is a drawing illustrating an example of the configuration of a network using the integrated circuit chips 10B and devices 15B of FIG. 11. In FIG. 12, the similar elements as those of FIG. 10 are referred to by the similar numerals, and a description thereof will be omitted. In FIG. 12, the integrated circuit chip 10B is illustrated as a repeater 10B. This reflects the fact that the integrated circuit chip 10B solely performs controls for signal input and output as well as switching.

In this configuration, the host circuits (devices 15B) are provided as externally attached devices, which makes it possible for all the integrated circuit chips 10B to have an identical configuration. The devices 15B may be freely arranged, swapped, and replaced. More flexible functionality may thus be achieved as a system as a whole.

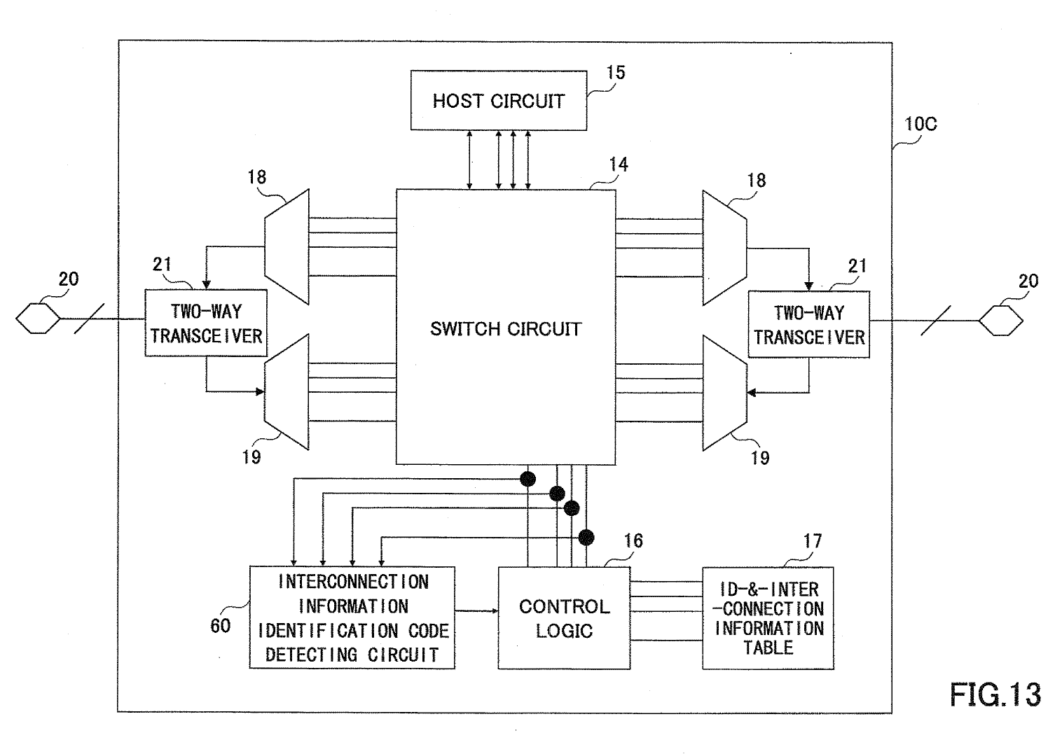

FIG. 13 is a drawing illustrating a third embodiment of the integrated circuit chip. In FIG. 13, the similar elements as those of FIG. 9 are referred to by the similar numerals, and a description thereof will be omitted.

An integrated circuit chip 10C illustrated in FIG. 13 differs from the integrated circuit chip 10A illustrated in FIG. 9 in that an interconnection information identification code detecting circuit 60 is provided in place of the interconnection information input terminal 50. In this configuration, the transmission and reception of interconnection information are performed not through dedicated terminals but through data transmission and reception ports (i.e., through two-way input-output ports 20) The interconnection information identification code detecting circuit 60 monitors a signal input from the two-way input-output ports 20 to identify a header when the header (i.e., identification code) indicative of interconnection information is received. When the interconnection information identification code detecting circuit 60 identifies a header, the control logic 16 recognizes that the received data is not normal data but interconnection information. The control logic 16 then modifies the ID-&-interconnection information table 17 in response to the contents of the received data. In response to the contents of the modified ID-&-interconnection information table 17, the control logic 16 controls couplings of the switch circuit 14. This configuration requires hardware (i.e., interconnection information identification code detecting circuit 60) for identifying received data as interconnection information. However, there is no need to lay out a dedicated control line (e.g., the control signal line 52 illustrated in FIG. 10) for distributing interconnection information.

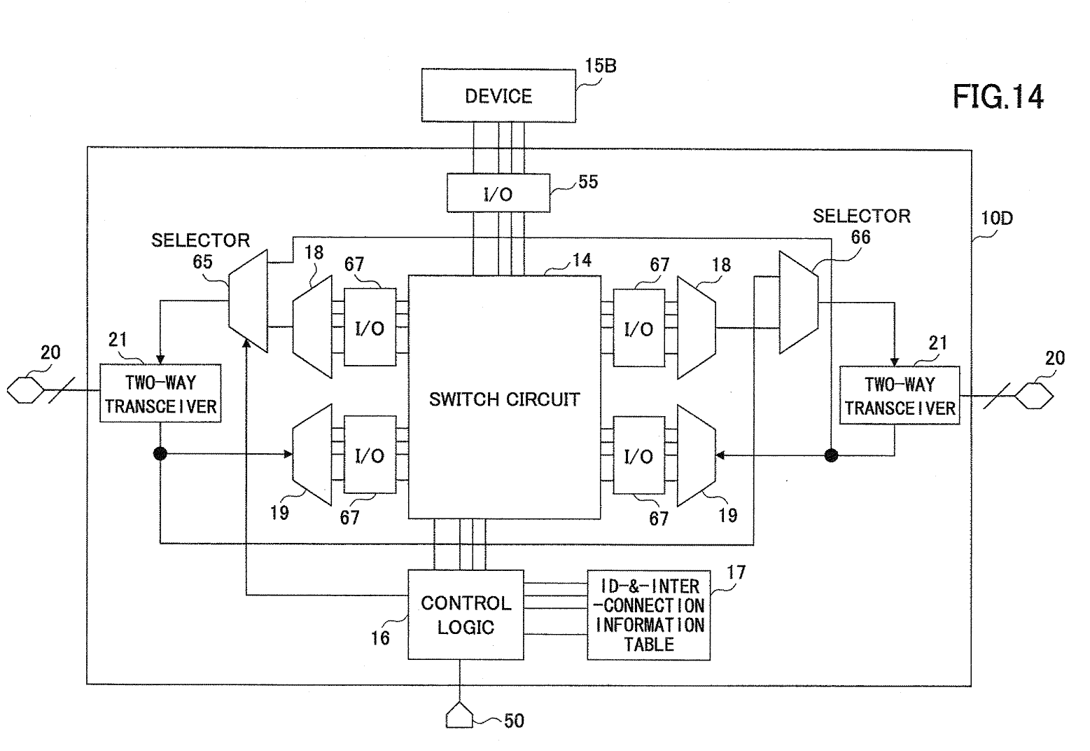

FIG. 14 is a drawing illustrating a fourth embodiment of the integrated circuit chip. In FIG. 14, the similar elements as those of FIG. 11 are referred to by the similar numerals, and a description thereof will be omitted.

An integrated circuit chip 10D illustrated in FIG. 14 differs from the integrated circuit chip 10B illustrated in FIG. 11 in that a selector 65, a selector 66, and I/O units 67 are additionally provided. The I/O unit 67 includes an input-and-output-purpose buffer, and also has a clock-data-recovery function to reconstruct data signal timing by recovering a clock from the input data signal. With this arrangement, a correct timing data signal having the timing thereof properly recovered may be output from a data route through which data is input into one two-way input-output port 20 to pass through the two-way transceiver 21, the demultiplexer 19, the I/O unit 67, the switch circuit 14, the I/O unit 67, the multiplexers 18, and the two-way transceiver 21 for transmission from the other two-way input-output port 20.

The configuration illustrated in FIG. 14 is provided with the selector 65 and the selector 66, so that a data route having no clock-data-recovery function by the I/O units 67 may be selectively provided. Namely, the selector 66 may select either a route through which data is directly supplied from the two-way transceiver 21 on the left-hand side of the figure to the two-way transceiver 21 on the right-hand side of the figure or a data route that passes through I/O units 67 having a clock-data-recovery function. By the similar token, the selector 65 may select either a route through which data is directly supplied from the two-way transceiver 21 on the right-hand side of the figure to the two-way transceiver 21 on the left-hand side of the figure or a data route that passes through I/O units 67 having a clock-data-recovery function. In FIG. 14, a direct data route that does not pass through the clock-data-recovery function is illustrated as if it did not pass through the switch circuit 14 for the sake of convenience of explanation. In reality, however, such a direct data route may also be subjected to coupling control by the switch circuit 14 based on the interconnection information.

With the configuration as described above, it is possible to switch between a data transfer mode that provides a clock-data-recovery function and a data transfer mode that recovers waveform by use of buffers. The data transfer mode that recovers waveform offers an advantage in that signal transmission delay is relatively smaller. When the distance of a coupling between chips is short, sufficient signal quality may be maintained by performing a level recovery. In such a case, the data transfer mode that performs a waveform recovery is preferable.

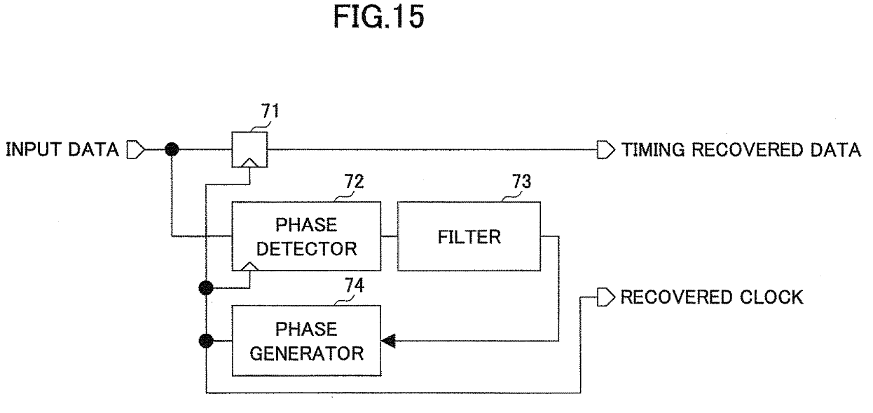

FIG. 15 is a drawing illustrating an example of the configuration of a clock-data-recovery circuit. The clock-data-recovery circuit illustrated in FIG. 15 is provided in the I/O units 67 illustrated in FIG. 14.

The clock-data-recovery circuit illustrated in FIG. 15 includes a flip-flop 71, a phase detector 72, a filter 73, and a phase generator 74. The flip-flop 71 loads input data in synchronization with the timing of a clock signal generated by the phase generator 74. In response to the timing of the clock signal generated by the phase generator 74, the phase detector 72 determines a signal value at the data center timing of an input data signal and also determines a signal value at the boundary timing between data. The phase detector 72 then compares phases between the determined signal values. The results of phase comparison performed by the phase detector 72 are temporally integrated by the filter 73. The phase generator 74 generates a clock signal having a phase responsive to the output of the filter 73.

When the clock signal generated by the phase generator 74 corresponds to the correct data determination timing, the determined signal values at the boundary timings between data that exhibit level transitions are almost uncorrelated with the data values. On the other hand, when the clock signal generated by the phase generator 74 is ahead of or falls behind the correct data determination timing, the determined signal values at the boundary timings between data that exhibit level transitions show correlation with the data values. The long-term observation of the phase comparison results by the filter 73 makes it possible to determine whether the clock signal generated by the phase generator 74 is ahead of or falls behind the correct data determination timing. The phase generator 74 generates a clock signal based on the output of the filter 73, so that the generated clock signal has the phase thereof matching the correct data determination timing. The flip-flop 71 may obtain correct data having a recovered timing by use of the clock signal having the correct timing.

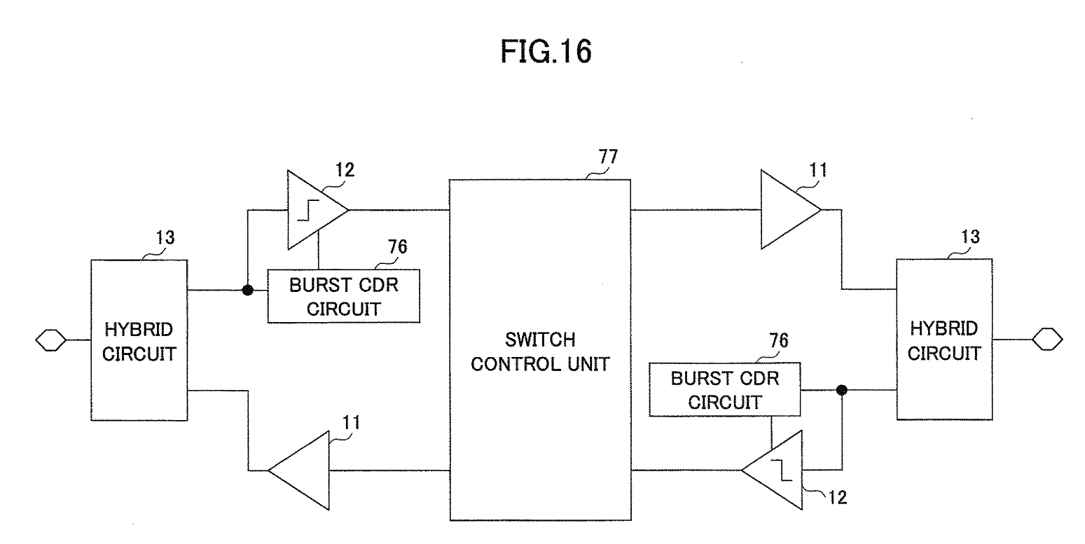

FIG. 16 is a drawing illustrating an example of the configuration that uses a burst mode CDR in the integrated circuit chip. In FIG. 16, the similar elements as those of FIG. 1 are referred to by the similar numerals, and a description thereof will be omitted. In FIG. 16, the switch circuit 14, the multiplexers 18, and the demultiplexers 19 illustrated in FIG. 1 are consolidated and illustrated as a switch control unit 77.

A burst CDR circuit 76 for performing a burst-mode CDR (i.e., clock data recovery) is coupled to each receiver 12. With this provision, it is possible for each receiver 12 to output data having its timing recovered by recovering a clock signal at high speed from a received signal.

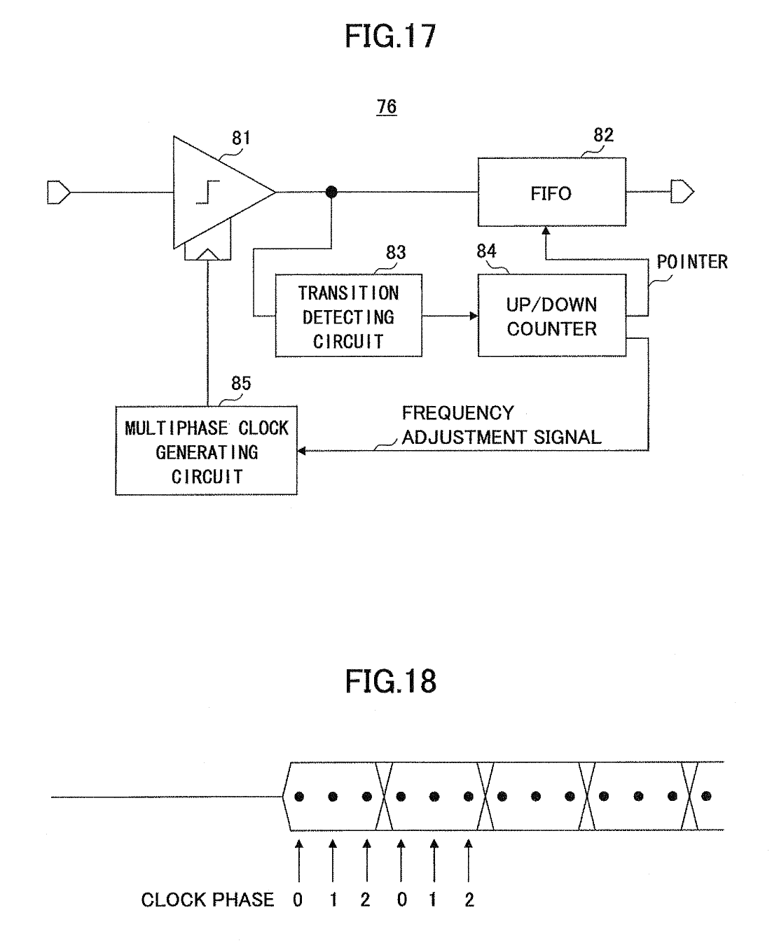

FIG. 17 is a drawing illustrating an example of the configuration of the burst CDR circuit 76. The burst CDR circuit 76 illustrated in FIG. 17 includes a data determination circuit 81, a FIFO 82, a transition detecting circuit 83, an up/down counter 84, and a multiphase clock generating circuit 85. The data determination circuit 81 samples an input signal at the edge timings of plural clock signals having different phases generated by the multiphase clock generating circuit 85, thereby outputting data values obtained at the sampling points. Due to oversampling, the positions of sampling points have timings as illustrated in FIG. 18, for example.

The transition detecting circuit 83 monitors sampled data values to detect the position at which a data value transition occurs. The output of the transition detecting circuit 83 is a signal indicating “up” or “down”. In response to this signal, the count of the up/down counter 84 goes up or goes down. The up/down counter 84 supplies a pointer responsive to the value of the count to the FIFO 82. The FIFO 82 outputs a data value situated at the position indicated by the pointer.

The position of the pointer is shifted forward or backward in response to the position of the transition detected by the transition detecting circuit 83, so that a correct data value situated at the position (i.e., timing) shifted by ½ of the data width from the transition position (i.e., data boundary position) may be output from the FIFO 82. The up/down counter 84 supplies a frequency adjustment request signal to the multiphase clock generating circuit 85 when its count value exhibits overflow or underflow. In response to the frequency adjustment request signal, the multiphase clock generating circuit 85 modifies the frequency of the output clock signals. With this arrangement, it is possible to adjust the frequency of the multiphase clock signals to follow the signal frequency even if the signal frequency is deviated from the frequency of the clock signals generated by the multiphase clock generating circuit 85.

A normal clock-recovery circuit does not recover a clock if the input signal is stopped for a long period. When signal reception starts thereafter, it takes a lengthy time before a clock is recovered to correctly receive a signal. The burst CDR circuit 76 described above uses a burst mode to recover a clock at high speed even when signal reception resumes after an unlimited length of a constant input signal level (i.e., after a long period of absence of signal input). Namely, the input signal may be suspended for an unspecified length of time, which offers an advantage in that there is no need to limit the signal formats used.

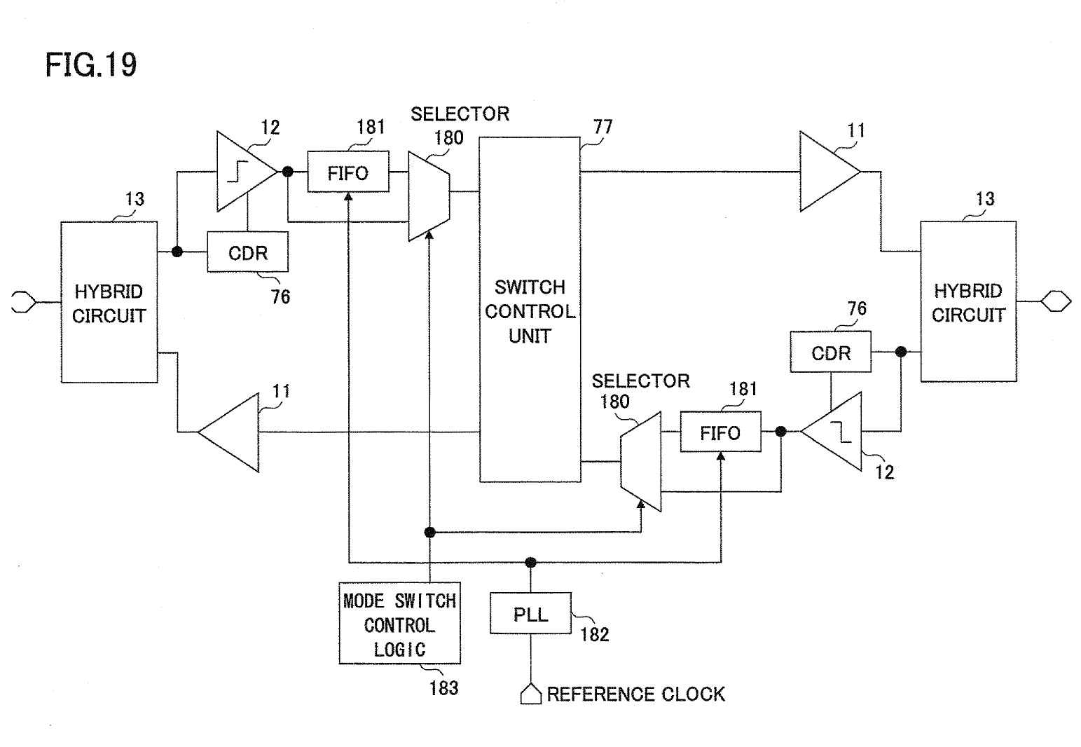

FIG. 19 is a drawing illustrating an example of the configuration in which a clock source for signal transmission is selectable. In FIG. 19, the similar elements as those of FIG. 16 are referred to by the similar numerals, and a description thereof will be omitted.

In the configuration illustrated in FIG. 19, the value of a timing-recovered received signal that is output from the receiver 12 provided with the burst CDR circuit 76 is input into a FIFO 181 for storage therein. A PLL (phase locked loop) circuit 182 generates an internal clock signal based on a reference clock signal supplied from the system. At the timing indicated by the internal clock signal generated by the PLL circuit 182, a signal value stored in the FIFO 181 is read out. A selector 180 selects either the timing-recovered data signal output from the receiver 12 or the data signal output from the FIFO 181 synchronized with the reference clock signal.

With the above-noted configuration, it is possible to select either the clock having its timing recovered from data or the global clock (i.e., reference clock) supplied from the system to use the selected clock as a clock source for signal transmission. When a system is constructed, the selection of a clock source greatly differs depending on the philosophy of the system design. Further, the selection of a clock source also depends on whether a normal operation mode is employed or a test operation mode is employed. The configuration as illustrated in FIG. 19 provides an advantage in that various needs regarding a clock source may be satisfied.

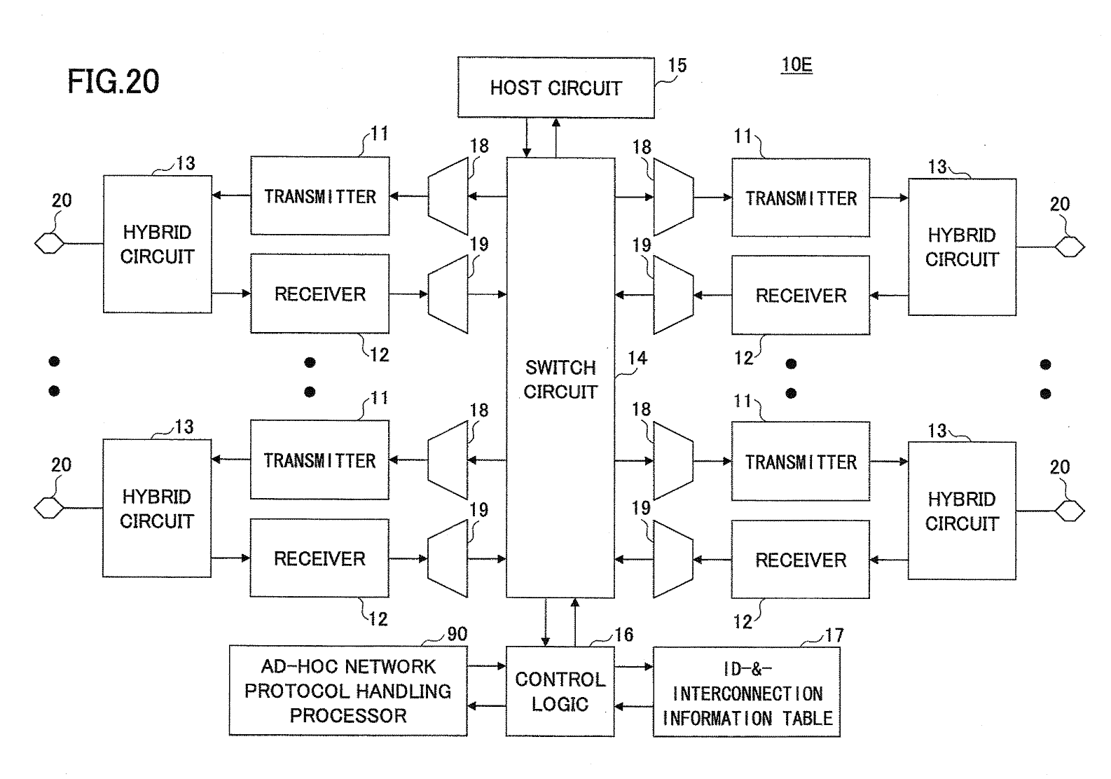

FIG. 20 is a drawing illustrating a fifth embodiment of the integrated circuit chip. In FIG. 20, the similar elements as those of FIG. 1 are referred to by the similar numerals, and a description thereof will be omitted.

An integrated circuit chip 10E illustrated in FIG. 20 differs from the integrated circuit chip 10 illustrated in FIG. 1 in that an ad-hoc network protocol handling processor 90 is newly provided. The ad-hoc network technology is an already established technology, and is standardized as ZigBee, UWB, and Bluetooth of IEEE802.15, for example. The ad-hoc network protocol handling processor 90 is provided with a communication route search function and a rerouting function for the purpose of coping with route changes such as an insertion or removal of a device such as a repeater along a communication route.

The ad-hoc network is a method of constructing a network when a plurality of terminals are in existence at random for wireless communication. In the case of wire communication, also, a reliable network may be constructed by using a similar method to the ad-hoc network method if the number of interconnections is so large as to be regarded as random couplings.

Specifically, unique IDs are distributed from the route device to all devices by utilizing parent-child relationships. Then, device information is transmitted to the route device through the parent-child-relation tree. The configuration of interconnections is determined inside the route device (e.g., processor), and, then, the interconnection information is distributed to each device. Different from a wireless system, coupling relationships between devices do not change dynamically. A simpler algorithm thus suffices to form a network. Such a configuration may cope with the randomness of interconnections and a failure such as a line decoupling, and is advantageously applicable to a system having a large number of interconnections.

According to at least one embodiment, a plurality of integrated circuit chips as described above are used to construct a network, and the couplings of the switch circuit inside each chip are controlled based on the interconnection information, thereby making it possible to freely set relationships between signal senders and signal receivers. When signal transmission is performed between the chips after setting the relationships between the signal senders and receivers, each and every signal transmission is achieved through a one-to-one coupling (i.e., point-to-point coupling) from a two-way input-output port to another two-way input-output port, thereby attaining high-speed signal transmission. Any desired coupling is established by use of the switchable coupling function of the switch circuit. This ensures the flexibility of interconnections, and reduces the number of pins. Since the two-way input-output port is usable as both an input port and an output port without a distinction therebetween, physical couplings between the chips may be freely established without considering which is an input port and which is an output port. This serves to further reduce the number of pins.

Although the embodiments are numbered with, for example, “first,” “second,” or “third,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) s have been described in detail, it should be understood that the various changes, substitutions, and alterations could be made hereto without departing from the spirit and scope of the invention.

What is claimed is:

1. An integrated circuit chip, comprising:
a plurality of two-way transceivers capable of simultaneously transmitting and receiving signals;
a switch circuit coupled to the plurality of two-way transceivers and to a given node to provide switchable couplings between the plurality of two-way transceivers and the given node;
an interconnection information storage unit to store interconnection information; and
a control circuit to set the couplings of the switch circuit in response to the interconnection information.

2. The integrated circuit chip as claimed in claim 1, comprising a host circuit coupled to the given node.

3. The integrated circuit chip as claimed in claim 2, wherein the host circuit is at least one of a processor and a memory.

4. The integrated circuit chip as claimed in claim 1, wherein the given node is an input and output port to which an external host circuit is connectable.

5. The integrated circuit chip as claimed in claim 1, comprising a dedicated port configured to receive the interconnection information.

6. The integrated circuit chip as claimed in claim 1, wherein the control circuit receives the interconnection information through at least one of the plurality of two-way transceivers, and stores the received interconnection information in the interconnection information storage unit.

7. The integrated circuit chip as claimed in claim 1, wherein at least one of the plurality of two-way transceivers includes a receiver circuit configured to detect whether an active signal is being received from an exterior.

8. The integrated circuit chip as claimed in claim 7, wherein in response to detection by the receiver circuit that an active signal is not being received, the control circuit sets an output of a two-way transceiver corresponding to the receiver circuit to a high impedance state.

9. The integrated circuit chip as claimed in claim 1, comprising a clock-recovery circuit to recover a clock from a signal received through the plurality of two-way transceivers and to reconstruct data timing of the received signal based on the recovered clock.

10. The integrated circuit chip as claimed in claim 9, wherein the clock-data-recovery circuit is a clock-data-recovery circuit capable of performing burst-mode signal reception.

11. The integrated circuit chip as claimed in claim 9, comprising a selector operative to select either one of a first signal route having an intervening data timing recovery function provided by the clock-data-recovery circuit and a second signal route having no intervening data timing recovery function provided by the clock-data-recovery circuit.

12. The integrated circuit chip as claimed in claim 9, comprising:
a timing recovery circuit to recover data timing of the received signal in response to a clock signal supplied from an exterior separately from the received signal; and
a selector operative to select either one of an output of the timing recovery circuit and an output of the clock-data-recovery circuit.

13. The integrated circuit chip as claimed in claim 1, comprising an ad-hoc network protocol handling processor to form an ad-hoc network.

14. A circuit network, comprising:
a plurality of integrated circuit chips having a plurality of two-way input-output ports; and
signal lines to provide one-to-one couplings between the two-way input-output ports to connect between the plurality of integrated circuit chips,
wherein each of the plurality of integrated circuit chips includes:
a plurality of two-way transceivers capable of simultaneously transmitting and receiving signals;
a switch circuit to provide switchable couplings between the plurality of two-way transceivers and the given node;
an interconnection information storage unit to store interconnection information; and
a control circuit to set the couplings of the switch circuit in response to the interconnection information.

15. The circuit network as claimed in claim 14, wherein the signal lines are arranged to cascade-connect the plurality of integrated circuit chips in one line.

16. The circuit network as claimed in claim 14, comprising a host circuit coupled to the given node.

17. The circuit network as claimed in claim 16, wherein the host circuit is at least one of a processor and a memory.
